(19) United States
(12) Patent Application Publication
(10) Pub. No.: US 2025/0011085 A1
(43) Pub. Date: Jan. 9, 2025

(54) IMPROVED LOAD HANDLING DEVICE FOR AUTOMATED WAREHOUSES

(71) Applicant: AUTOMHA S.P.A., Azzano San Paolo (Bergamo) (IT)

(72) Inventors: Marco BRIGNOLI, Azzano San Paolo (Bergamo) (IT); Walter DANNE, Azzano San Paolo (Bergamo) (IT)

(21) Appl. No.: 18/710,742

(22) PCT Filed: Nov. 17, 2022
(86) PCT No.: PCT/IB2022/061079

§ 371 Date: May 16, 2024

(30) Foreign Application Priority Data
Nov. 19, 2021 (IT) 102021000029303

(51) Int. Cl. B65G 1/04

(52) U.S. Cl. CPC B65G 1/0492

(57) ABSTRACT

A load handling device for automatically storing a load in an automated warehouse has a base frame onto which wheels are rotatably connected to allow translation of the load handling device along a storage aisle. First handling members are operatively connected to one or more of the wheels. Operational portions define a temporary support plane for the load, and second handling members are operatively connected to the operational portions for moving the operational portions between a base position and a lifting position. A measuring wheel rotatable about a wheel rotation axis is connected to the base frame along a wheel translation direction. A connecting coupling transfers rotational motion of the measuring wheel to an angular position detection device having a device rotation axis parallel to the wheel rotation axis even during an offset variable in time along the wheel translation direction between the device rotation axis and the wheel rotation axis.

### FIELD OF APPLICATION

The present invention falls within the field of the production of automated systems for the storage of items on pallets in an automated warehouse.

In particular, the present invention relates to a load handling device, in particular for handling pallets containing articles, for automated warehouses.

### PRIOR ART

Automated warehouses structured to allow the automatic storage of pallets are known in the art.

From a design point of view, these warehouses normally employ load-bearing structures comprising a structure with shoulders and uprights that defines a plurality of storage aisles of variable dimensions as a function of the expected loads. The pallets are arranged and picked up along/from such aisles through automated devices, called satellites or shuttles. In practice, these devices deposit, automatically and in series, a plurality of pallets on support guides arranged along the storage aisle. In more detail, this deposit normally takes place starting from one end of an aisle or in any case from the first free position identified within the aisle itself.

In order to perform the operations for which it is intended, the satellite normally comprises a frame provided with a plurality of wheels so as to allow the satellite to be moved along the storage aisle.

These wheels are actuated by suitable handling means which generally consist of electric motors, which are operatively controlled by command and control means and which are powered by suitable power supply means, such as batteries.

The satellite further comprises two distinct sections suitable for providing a support surface for the pallet, as well as position detection means suitable for determining the position of the satellite in one or more points of the aisle, or means for detecting the position in a continuous manner, for example by means of laser position detection systems.

One of the most important drawbacks encountered in systems of this type is the need to monitor and verify the position of the satellite along the aisle as accurately as possible and at the same time to ensure high reliability and safety of the position detection system over time.

In fact, disadvantageously, in the devices of the prior art, the devices for reading the relative position of the satellite within the aisle are subject to breakage, often due to blows received by the satellite while traveling along the rails of the aisles, due to the roughness present on the aisles or during the vertical movement of the device to reach the aisle (that is due to the so-called “slingshot effect”).

Furthermore, the roughness present on the aisle may cause incorrect readings of the position, especially in odometric type position detection systems.

### DISCLOSURE OF THE INVENTION

The need to remedy the aforementioned drawbacks relating to the prior art is therefore strongly felt.

In particular, an object of the present invention is to provide a load handling device which is capable of overcoming the drawbacks of the prior art.

This object is achieved by a load handling device according to the accompanying independent claims. The dependent claims describe preferred embodiments.

### BRIEF DESCRIPTION OF THE DRAWINGS

The features and advantages of the load handling device according to this invention will appear more clearly from the following description, made by way of an indicative and non-limiting example with reference to the accompanying figures, wherein:

FIG. 1 shows a perspective view of an automated storage system according to an embodiment of this invention;

FIG. 2 shows a front perspective view of a portion of an automated storage system according to an embodiment of this invention;

FIG. 3 shows a perspective view of a detail portion of an automated storage system according to an embodiment of the present invention, in which a load handling device is shown in a first operating position on a master vehicle;

FIG. 4 shows a perspective view of a detail portion of an automated storage system according to an embodiment of the present invention, in which a load handling device is shown in a second operating position, inside an aisle of the system, unloaded from the master vehicle;

FIG. 5 shows an overall axonometric view of a load handling device according to an embodiment of this invention;

FIG. 6 shows a lateral planar view of the load handling device of FIG. 5;

FIG. 7 shows a cross-sectional planar view of the load handling device of FIG. 5 along a sectional plane perpendicular to the rolling plane of the wheels;

FIG. 8 is a top planar view of the load handling device of FIG. 5, in which the upper cover has been fictitiously removed to allow a view of the internal components;

FIG. 9 shows an axonometric view of a connecting coupling connected to a measuring wheel and to a device for detecting the angular position of the load handling device, according to an embodiment of this invention;

FIG. 10 shows an enlargement of the circled detail C indicated in FIG. 7.

FIG. 11 shows a front planar view of a portion of the load handling device, wherein, in particular, the measuring wheel and a translation guide are visible;

FIG. 12 shows a sectional view along the sectional plane A-A of FIG. 11, in which both the measuring wheel and the translation guide and the connecting coupling are visible;

FIG. 13 shows a sectional view of the angular position detection device according to an embodiment of this invention.

### DETAILED DESCRIPTION

Despite the present invention is described below with reference to preferred embodiments shown in the drawings, the present invention is not limited to the embodiments described below and shown in the tables. On the contrary, the described and represented embodiments clarify some aspects of the present invention.

The present invention has proved to be particularly advantageous with reference to the implementation of a load handling g device suitable for moving within a warehouse in an autonomous/semi-autonomous and preferably self-powered manner, as better described hereinafter.

However, it should be pointed out that the present invention is not limited to the implementation of an autonomous and self-powered device. On the contrary, the present invention finds convenient application in all cases involving the use of a device which moves within a suitably powered warehouse, for example a power supply system on fixed guides on which the device rests.

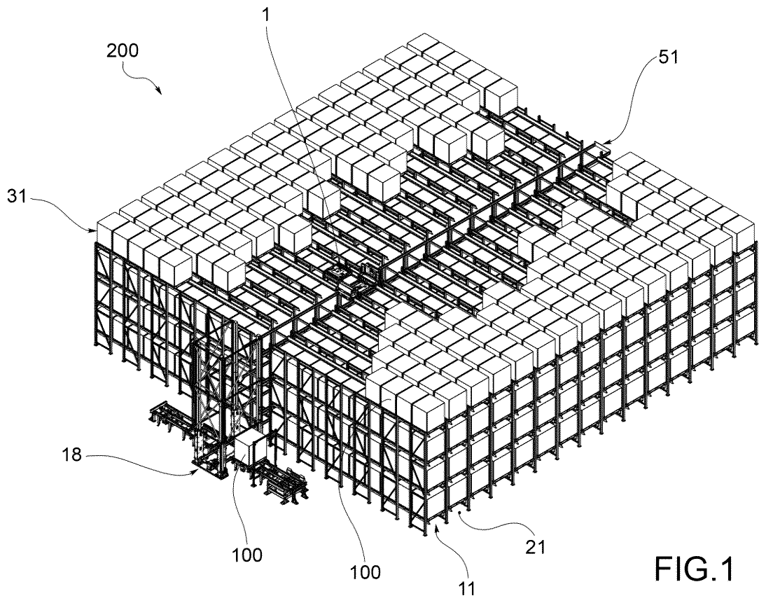

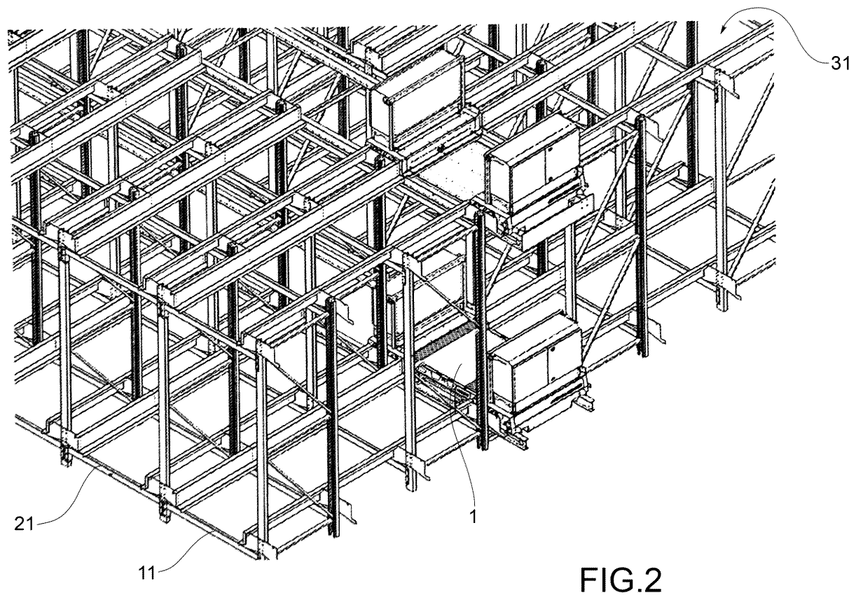

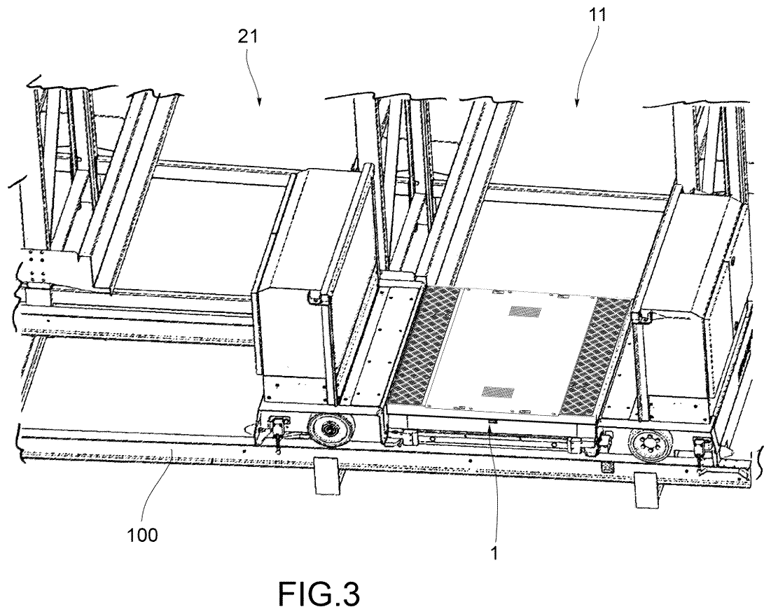

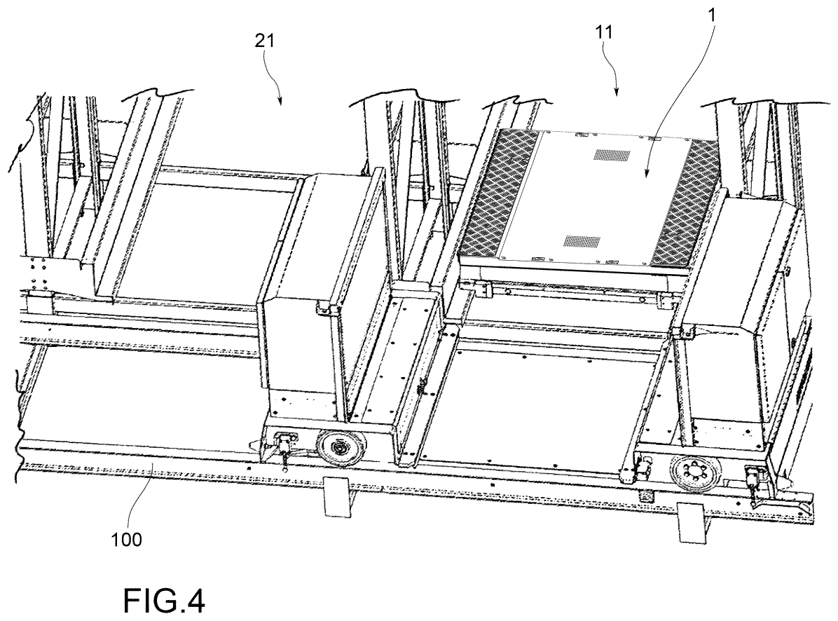

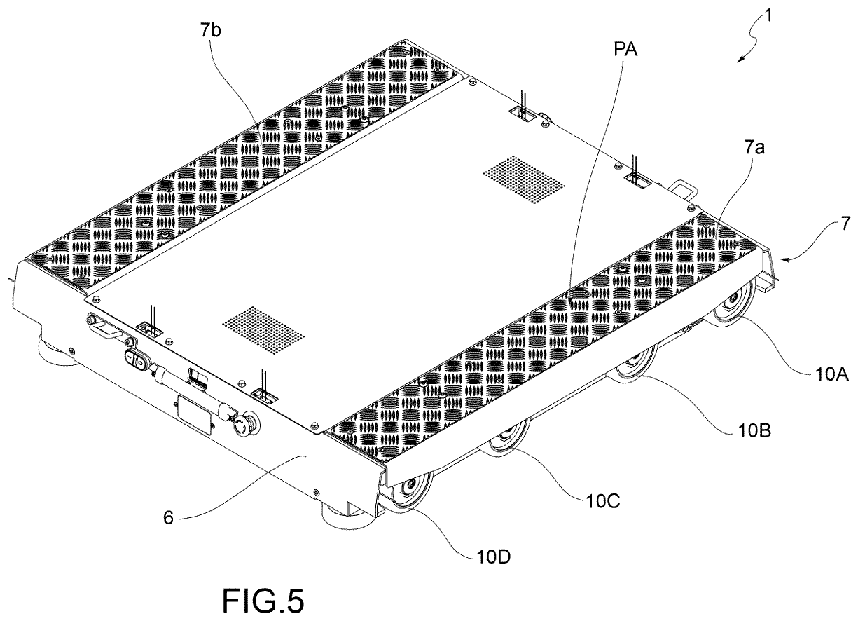

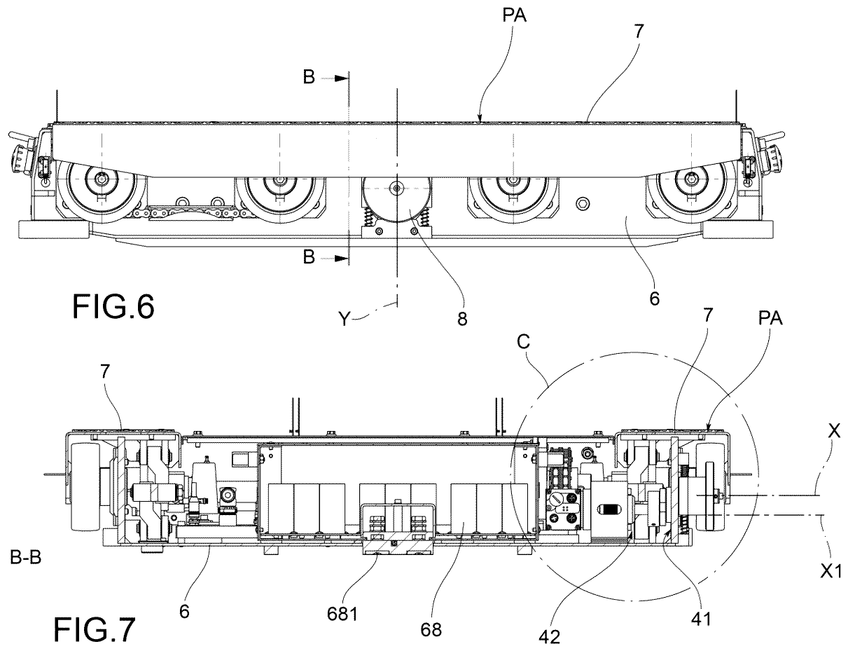

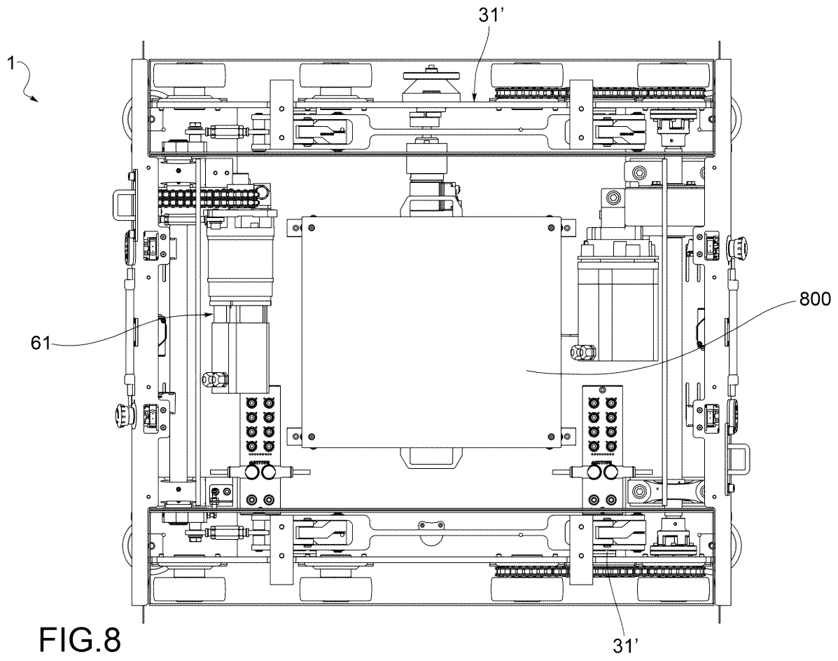

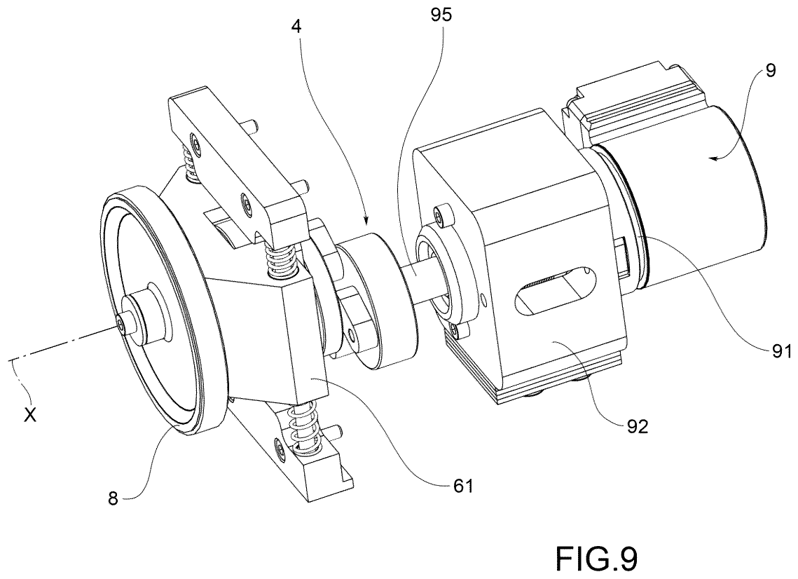

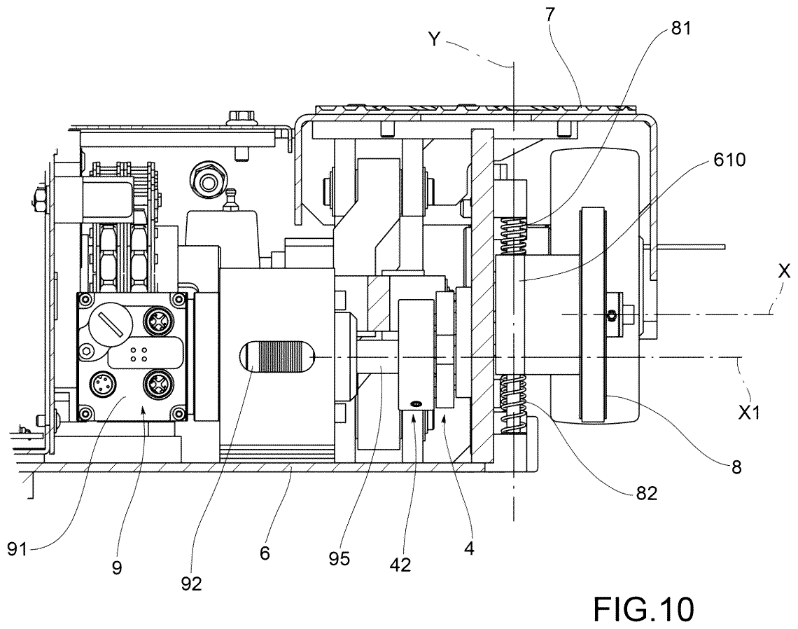

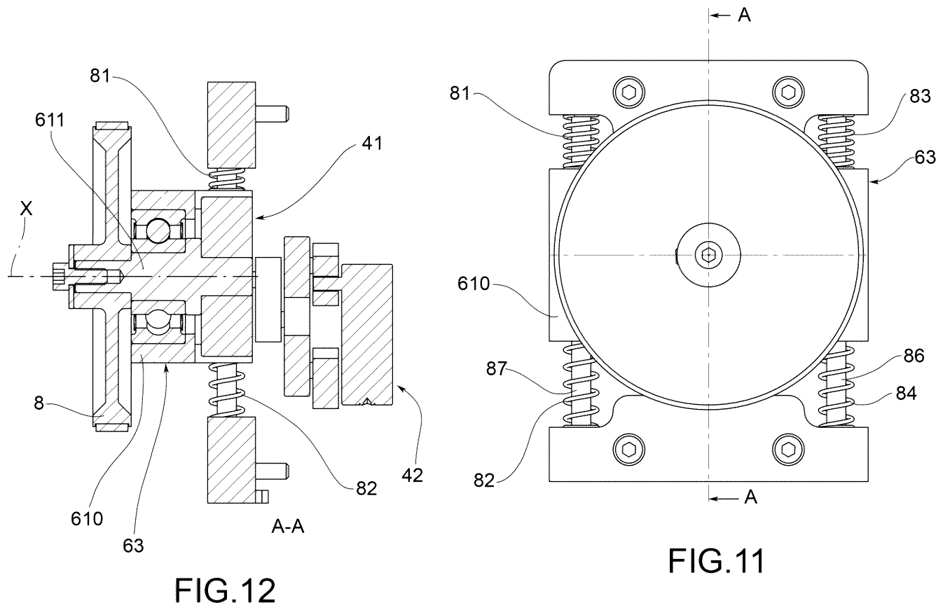

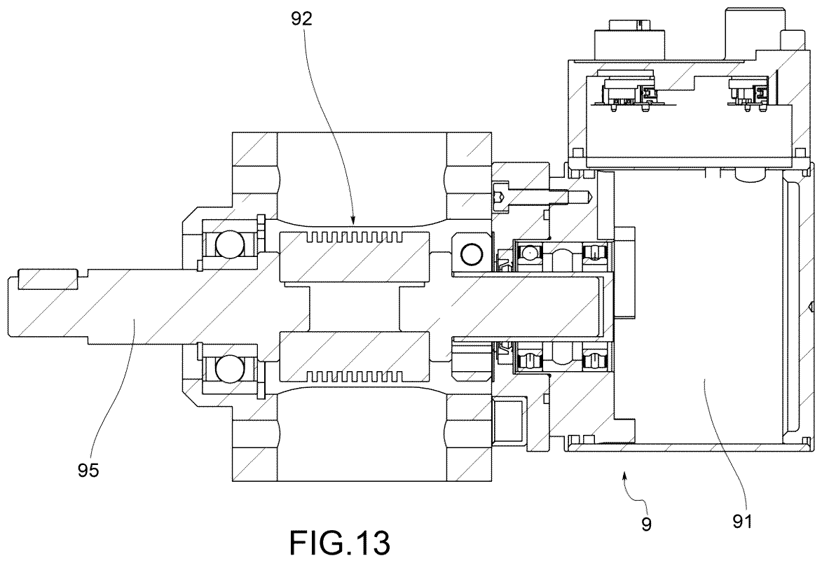

FIG. 1 schematically shows a warehouse 200 for storing loads 100, typically pallets, comprising a load handling device 1 according to a preferred embodiment of the invention.

The warehouse 200 shown in the figures by way of example has a simple layout and preferably comprises storage aisles 11, 21, 31 arranged laterally with respect to a central aisle 51.

The warehouse 200 also preferably comprises a loading/unloading station 18 for the loads, that is an area on which a load 100 which must be stored in a predetermined compartment of the warehouse 200 is placed, or an area on which a load taken from a compartment of warehouse 200 is placed.

The handling of a load 100 within the warehouse 200 is advantageously carried out by the load handling device 1 according to the invention.

The handling of the load in the warehouse 200 consists, preferably, in handling said load from the loading/unloading station 18 towards and in the aisles 11, 21, 31.

The load handling device 1 according to the invention preferably allows the handling of loads of large dimensions and weights, such as pallets, but other types of articles are not excluded.

The load handling device 1 according to the invention is therefore in particular suitable for handling pallets containing articles, for automatically storing the load 100 in a warehouse 200. The load handling device 1 comprises a base frame 6 onto which wheels 10A, 10B, 10C, 10D are rotatably connected, which wheels are suitable for allowing the translation of the load handling device 1 along a storage aisle 11, 21, 31 of the warehouse 200.

The load handling device 1 also comprises first handling means 61 arranged inside said base frame 6 and operatively connected to one or more of said wheels 10A, 10B for achieving the translation of the load handling device 1.

The load handling device 1 comprises one or more operational portions 7 defining a temporary support plane PA for the load 100, and second handling means 31 arranged inside the base frame 6 and operatively connected to these operational portions 7 for moving them with respect to the frame base 6 between a base position and a lifting position vertically spaced from the base position.

In one embodiment, the one or more operational portions 7 comprise a pair of support bars 7a, 7b.

Preferably, first handling means 61 comprise one or more electric motors, associated with one or two of the wheels 10A, 10B. Of the total number of wheels 10A, 10B, 10C, 10D it is preferable that only some of them are driving wheels and that the remaining ones are idlers.

In a preferred embodiment, the device 1 comprises main power supply means 68 (or primary power supply means) mounted on board the device itself so as to make the device autonomous and self-powered.

In a preferred embodiment, the main power supply means comprise supercapacitors and/or batteries, for example lithium batteries, positioned in the base frame 6. These supercapacitors and/or batteries are rechargeable through electric recharge connections 681, supported by the base frame 6.

In an alternative embodiment, a power supply system for the motors may be provided by means of power bars located on the floor along the aisle and a brush on board the device which, placed in continuous contact with the power bar, transfers the electric power supply energy for the parts on board the device.

According to an embodiment, a central control unit 800 is integrally associated with the base frame 6 of the device 1. The central unit 800 controls all the moving parts of the device 1 and the communication with the sensors. Preferably, the central unit 800 also communicates with a warehouse management unit, on which a warehouse software manages the operation of the warehouse 200 and in particular the movements of the device 20 within the warehouse 10. The communication between the central unit 800 and the warehouse management unit is preferably wireless communication.

The central unit 800 is powered by said main electric power supply means.

The load handling device 1 also comprises a measuring wheel 8 which is rotatable about a wheel rotation axis X and connected to the base frame 6 in a translatable manner along a wheel translation direction Y incident, preferably perpendicular, to the support plane PA for the load 100.

Furthermore, the load handling device 1 comprises a device 9 for detecting the angular position of the measuring wheel 8, comprising a device rotation axis X1 parallel to the wheel rotation axis X.

Furthermore, a connecting coupling 4 is integrally connected on a first side 41 thereof to the measuring wheel 8 and on a second side 42 thereof to the angular position detection device 9. Such connecting coupling 4 is a torsionally rigid coupling suitable for transferring the rotational motion of the measuring wheel 8 to the angular position detection device 9 in a homokinetic and synchronized manner, even during an offset that is variable in time along the wheel translation direction Y between the device rotation axis X1 and the wheel rotation axis X.

Preferably, the connecting coupling 4 is an articulated coupling, suitable for allowing an offset that is variable in time along the wheel translation direction Y between the device rotation axis X1 and the wheel rotation axis X of at least two millimeters, preferably at least five millimeters.

According to an embodiment, the connecting coupling 4 is an articulated coupling comprising three or more connecting rods suitable for alternately transmitting pushing and pulling forces, thus uniformly taking the rotational motion of the wheel rotation axis X to the device rotation axis X1.

According to a preferred embodiment, the connecting coupling 4 is a coupling known as a Schmidt coupling.

According to an advantageous embodiment, the load handling device 1 comprises one or more elastic elements 81, 82, 83, 84 suitable for being elastically deformed during translation of the measuring wheel 8 along the wheel translation direction Y.

According to an embodiment, the load handling device 1 comprises a translation guide 86, 87, constrained to the base frame 6 and a wheel coupling assembly 63 comprising a coupling body 610 engaged in a translatable manner along the translation guide 86, 87 to translate along the wheel translation direction Y. Furthermore, a wheel shaft 611, to which the measuring wheel 8 is integrally joined, is rotatable with respect to the coupling body 610 about the wheel rotation axis X.

Preferably, the translation guide comprises a pair of rods 86, 87 and the one or more elastic elements 81, 82, 83, 84 are arranged around each of said pair of rods.

Preferably, the coupling body 610 is slidingly engaged to said pair of rods 86, 87 and is suitable for engaging the one or more elastic elements 81, 82, 83, 84 to deform them during the translation of the measuring wheel 8 in the wheel translation direction Y.

According to an embodiment, the angular position detection device 9 comprises an electronic encoder 91 (for example a position encoder, preferably an optical encoder) and an elastic coupling 92 interposed between the electronic encoder 91 and the connecting coupling 4.

Preferably, the elastic coupling 92 comprises a coupling shaft 95 integral in rotation with the second side 42 of the connecting coupling 4. This coupling shaft 95 is coaxial to the device rotation axis X1 and is suitable for transferring the rotational motion of the second side 42 of the connecting coupling 4 to the electronic encoder 91.

Innovatively, the present invention successfully overcomes the cited drawbacks with respect to the devices of the prior art.

In particular, by virtue of the presence of a connecting coupling which allows high offsets between the measuring wheel axis and the position detection device axis, it is possible to adequately compensate and absorb all the mechanical shocks that the device undergoes during operation. This guarantees both continuous measurement reliability and high reliability of the position sensor which is no longer subjected to high mechanical shocks and consequent breakage.

In particular, advantageously, the measuring wheel which is translatable along the inclined direction with respect to the support plane (preferably in the vertical perpendicular direction, but optionally also in the horizontal direction) allows this wheel to always be floating and under pressure in contact with the aisle rails. In this way, contrary to what happens to the other wheels of the device, the measuring wheel does not undergo any elastic deformation due to the weight of the load and, therefore, a high measurement accuracy is guaranteed, irrespective of the weight and type of load supported by the handling device 1.

Furthermore, in a further advantageous manner, the presence of an elastic coupling further allows further residual shocks to be absorbed, even at high frequency, on the position reading encoder.

Advantageously, moreover, the improved reliability and strength of the position reading encoder ensures greater safety for the operators. In fact, the position reading encoder, in addition to measuring the distance to be covered (or already covered), is also a safety device. Since the speed of rotation of the odometric wheel is transformed into a tachometric speed, during the automatic cycles and even more so during the manual maneuvers, exceeding the set speeds causes instant and safe blocking of the vehicle. This safety circuit prevents the vehicle from falling from the storage aisles during the automatic cycles and also prevents any injuries to the operators (system maintainers).

A person skilled in the art may, in order to meet specific needs, make several changes to the embodiments of this invention or substitutions of elements with other functionally equivalent ones.

These variants are also contained within the scope of protection as defined by the following claims.

1. A load handling device for automatically storing a load in a warehouse, said load handling device comprising:
a base frame onto which wheels are rotatably connected, the wheels being suitable for allowing a translation of the load handling device along a storage aisle of the warehouse;
first handling means arranged inside said base frame and operatively connected to one or more of said wheels for achieving the translation of the load handling device,
one or more operational portions defining a temporary support plane for said load;
second handling means arranged inside said base frame and operatively connected to said one or more operational portions, for moving said one or more operational portions with respect to said base frame between a base position and a lifting position;
said load handling device further comprising;
a measuring wheel, rotatable about a wheel rotation axis, and connected to the base frame in a translatable manner along a wheel translation direction incident to the support plane;
an angular position detection device of the measuring wheel, comprising a device rotation axis, parallel to the wheel rotation axis;
and in that it comprises a connecting coupling, integrally connected on a first side thereof to the measuring wheel and on a second side thereof to the angular position detection device, said connecting coupling being a torsionally rigid coupling suitable for transferring a rotational motion of the measuring wheel to the angular position detection device in a homokinetic and synchronized manner, even during an offset variable in time along the wheel translation direction between the device rotation axis and the wheel rotation axis.

2. The load handling device of claim 1, wherein the connecting coupling is an articulated coupling, suitable for allowing an offset variable in time along the wheel translation direction between the device rotation axis and the wheel rotation axis of at least two millimeters.

3. The load handling device of claim 1, wherein the connecting coupling is an articulated coupling comprising three or more connecting rods suitable for alternately transmitting pushing and pulling forces, thus uniformly taking a rotational motion of the wheel rotation axis to the device rotation axis.

4. The load handling device of claim 1, wherein the connecting coupling is a Schmidt coupling.

5. The load handling device of claim 1, further comprising one or more elastic elements, suitable for being elastically deformed during translation of the measuring wheel along the wheel translation direction.

6. The load handling device of claim 1, further comprising a translation guide, constrained to the base frame and a wheel coupling assembly comprising a coupling body engaged in a translatable manner along the translation guide to translate along the wheel translation direction and a wheel shaft rotatable with respect to the coupling body about the wheel rotation axis, wherein the measuring wheel is integrally joined to the wheel shaft.

7. The load handling device of claim 6, wherein the translation guide further comprises a pair of rods,
wherein one or more elastic elements are arranged around said pair of rods,
and wherein the coupling body is slidingly engaged to said pair of rods and is suitable for engaging the one or more elastic elements to deform the one or more elastic elements during translation of the measuring wheel in along the wheel translation direction.

8. The load handling device of claim 1, wherein the angular position detection device comprises an electronic encoder and an elastic coupling interposed between the electronic encoder and the connecting coupling.

9. The load handling device of claim 8, wherein the elastic coupling comprises a coupling shaft integral in rotation with the second side of the connecting coupling, said coupling shaft being coaxial to the device rotation axis and being suitable for transferring rotational motion of the second side of the connecting coupling to the electronic encoder.

10. The load handling device of claim 1, wherein the load handling device is suitable for handling pallets containing articles.

11. The load handling device of claim 1, wherein the connecting coupling is an articulated coupling suitable for allowing an offset variable in time along the wheel translation direction between the device rotation axis and the wheel rotation axis of at least five millimeters.
